(19) United States
(12) Patent Application Publication
(10) Pub. No.: US 2022/0192453 A1
(43) Pub. Date: Jun. 23, 2022

(54) METHOD FOR OPERATING AN AUTOMATICALLY MOVING FLOOR TREATMENT APPLIANCE

(71) Applicant: Vorwerk & Co. Interholding GmbH, Wuppertal (DE)

(72) Inventors: Andrej MOSEBACH, Unna (DE); Henning HAYN, Hilden (DE)

(73) Assignee: Vorwerk & Co. Interholding GmbH, Wuppertal (DE)

(21) Appl. No.: 17/548,865

(22) Filed: Dec. 13, 2021

(30) Foreign Application Priority Data
Dec. 21, 2020 (DE) 10 2020 134 400.7

(51) Int. Cl. A47L 11/40; A47L 11/282

(52) U.S. Cl. CPC A47L 11/4011; A47L 11/282; A47L 11/4091; A47L 2201/06; A47L 2201/02; A47L 2201/04; A47L 11/4066

(57) ABSTRACT

A method for operating an automatically moving floor treatment appliance, wherein at least one floor treatment activity to be performed by the floor treatment appliance in a surrounding area is pre-planned for performance in a first time window having a defined start time and a defined time period. In the event that the first time window is not sufficient, at least a second time window is pre-planned, in which the floor treatment appliance continues the floor treatment activity. The floor treatment activity not completed upon the expiration of the first time window is stopped at the end of the defined time period of the first time window and is continued upon reaching a start time predefined for the second time window. The floor treatment plan specifies a cyclically successive floor treatment of several surrounding area subregions of the surrounding area according to a defined sequence of the surrounding area subregions.

### CROSS REFERENCE TO RELATED APPLICATIONS

Applicant claims priority under 35 U.S.C. § 119 of German Application No. 10 2020 134 400.7 filed Dec. 21, 2020, the disclosure of which is incorporated by reference.

### BACKGROUND OF THE INVENTION

### 1. Field of the Invention

The invention relates to a method for operating an automatically moving floor treatment appliance, wherein at least one floor treatment activity to be performed by the floor treatment appliance in a surrounding area is pre-planned for performance in a first time window, which is characterized by a defined start time and a defined time period, wherein, in the event that the first time window is not sufficient for the complete performance of the floor treatment activity, at least a second time window is pre-planned, in which the floor treatment appliance continues the performance of the floor treatment activity, wherein the floor treatment activity not completed upon the expiration of the first time window is stopped at the end of the defined time period of the first time window and is continued upon reaching a start time predefined for the second time window, wherein several floor treatment activities are defined as part of a treatment plan, which establishes an order of the floor treatment activities to be performed.

### 2. Description of the Related Art

Automatically moving floor treatment appliances as well as methods for the operation thereof are known in the prior art in various embodiments. Floor treatment appliances of this type are, for example, cleaning appliances, polishing appliances, waxing appliances, or the like. For example vacuuming appliances, mopping appliances, and others, are known in terms of cleaning appliances. These floor treatment appliances are used in domestic environments as well as in commercially used environments, for example office buildings, storage facilities, sales rooms, or others.

It is known to plan floor treatment activities to be performed by the floor treatment appliance in advance, for example by means of a calendar application, which can manage specific dates for one or several floor treatment activities. The dates are defined by a defined start time and a define time period, i.e. duration, which is available for performing the floor treatment activity. The time period simultaneously also defines an end time, at which the floor treatment activity is to be ended. A pre-planned time window for example after office hours until the next office hours, for example from 8 pm until 6 am, can be defined for a floor treatment inside an office building.

In the case of very large areas to be treated, it can happen that they cannot be cleaned completely during a single available time window. It is possible, for example, that the cleaning of an area is not concluded until the next business day because the area is too large in order to completely treat it in the available time period. When a floor treatment activity, which has thus been interrupted, is resumed in a subsequent time window, the floor treatment appliances according to the prior art act in such a way that they restart the floor treatment activity, starting at the earlier start time, wherein the floor treatment then takes place as before from the beginning, and the entire area cannot be treated completely, in turn, in the case of an identical available time period. This approach has the result that only the same surrounding area subregions of a surrounding area are treated again and again, while other surrounding area parts are consistently not treated and can thus get dirty to an increasing extent, for example.

### SUMMARY OF THE INVENTION

Based on the above-mentioned prior art, it is thus the object of the invention to create a method for operating an automatically moving floor treatment appliance, in the case of which a surrounding area comprising very large areas to be treated can also and in particular be treated completely.

To solve the above-mentioned object, it is proposed that the floor treatment plan specifies a cyclically successive floor treatment of several surrounding area subregions of the surrounding area according to a defined sequence of the surrounding area subregions, wherein, after completion of a floor treatment activity in a surrounding area subregion, which is defined as last surrounding area subregion of the sequence, a new floor treatment of the surrounding area subregions takes place according to the entire defined sequence, starting at a surrounding area subregion, which is defined as first surrounding area subregion of the sequence.

According to the invention, several floor treatment activities are defined as part of a treatment plan, wherein the treatment plan specifies an order of the floor treatment activities to be performed. This design is suitable in particular for floor treatment appliances, which can perform several different floor treatment activities. This applies, for example, to floor treatment appliances, which can complete different cleaning tasks, for example a mopping task and a vacuuming task, or to floor treatment appliances, to which various tools for treatment are available, which can apply various floor treatment intensities, or the like. When continuing a floor treatment activity, which was paused previously, in a next time window, an immediate or later change of the floor treatment activity can thus also occur, wherein an activity order of the predefined treatment plan is followed independently of the current time window. It is essential that a surrounding area subregion is to currently be treated, in which a defined floor treatment activity or several specific floor treatment activities are to be performed. The order of the floor treatment activities to be performed is thereby also coupled to the order of the surrounding area subregions to be treated.

The treatment plan specifies a cyclically successive floor treatment of several surrounding area subregions of the surrounding area according to a defined sequence of the surrounding area subregions, wherein, after completion of a floor treatment activity in a surrounding area subregion defined as last surrounding area subregion of the sequence, a new floor treatment of the surrounding area subregions takes place according to the entire defined sequence, starting at a surrounding area subregion defined as first surrounding area subregion of the sequence. The floor treatment for all surrounding area subregions of the surrounding area is thus initially continued in the course of several successive time windows up to a complete treatment of all surrounding area subregions. As soon as the treatment of the entire area of all surrounding area subregions has been concluded, a new floor treatment cycle is started, which includes a repetition of the previously performed floor treatment activities according to the defined sequence. Due to the fact that the sizes of the floor areas of the surrounding area subregions are not necessarily adapted to the available time windows, another division of the surrounding area to the time windows may result for the subsequent floor treatment cycle. Due to the changed initial situation at the beginning of the first time window of the new floor treatment cycle, a change of the already treated or non-treated subareas of the surrounding area, respectively, thus results.

A floor treatment activity, which cannot be performed completely during an available time window, is stopped upon reaching the end of the defined time period and is continued within a subsequent time window, namely where the floor treatment activity was terminated. This includes that the floor treatment activity is paused at the end of the first time window and is continued in the second time window in the previously treated surrounding area subregion of the surrounding area. The floor treatment activity is preferably continued at the same location of the surrounding area, where the floor treatment activity was stopped previously. The starting point for the continuation of the floor treatment activity in the second time window thus has the coordinates of the whereabouts of the floor treatment appliance upon expiration of the preceding time window. In an interim period between two time windows, the floor treatment appliance is preferably located at a defined location of the surrounding area, for example at a base station, which can perform a service activity on the floor treatment appliance. Such a base station can be, for example, a station, which has a charging device for charging an accumulator of the floor treatment appliance or which provides another service activity. The base station can also be configured, for example, for cleaning the floor treatment appliance, for transferring tools to the floor treatment appliance, for transferring consumables to the floor treatment appliance, or to accept material from the floor treatment appliance, for example suction material collected by the floor treatment appliance. Even if this is not preferred, an alternative process can provide that the floor treatment appliance waits at that location of the surrounding area, where the floor treatment activity was stopped upon the expiration of the time window. As soon as the next time window is reached, the floor treatment activity can then be continued at this location, without the floor treatment appliance having to initially move into that surrounding area subregion, in which the floor treatment activity is to be continued. At the end of a time window, a control means of the floor treatment appliance could furthermore also initially check whether the current location of the floor treatment appliance is suitable as place to wait, so that the floor treatment appliance has to optionally not move from this location in order to wait for the start time of a next time window. The floor treatment appliance can thus wait for the continuation of the floor treatment activity in a following time window exactly at the location where the floor treatment activity was stopped. As soon as the floor treatment activity as a whole is completed or all pre-planned floor treatment activities are completed, respectively, the floor treatment appliance can return to a base station or a predefined place to wait. The floor treatment process can then be started again, in particular by observing a defined minimum time period, which must have gone by, after the surrounding area was last treated. It is preferably prevented thereby that a surrounding area subregion is treated too frequently and the floor treatment appliance is thus operated unnecessarily. This helps in particular to save energy as well as to extend the service life of the floor treatment appliance. In the alternative, it can also be provided that after completion of the floor treatment activity during a time window, which has not expired yet, the floor treatment appliance seamlessly continues the floor treatment activity, namely preferably in a surrounding area subregion of the surrounding area, the treatment of which lags behind the most.

It is furthermore proposed that the surrounding area is divided into a plurality of defined surrounding area subregions, wherein the floor treatment activity is planned for performance in at least one specific one of the defined surrounding area subregions. According to this design, an order for surrounding area subregions of the surrounding area to be treated is preferably also established, so that the floor treatment appliance preferably moves within the surrounding area in a particularly time-saving and efficient manner. Neighboring surrounding area subregions are thereby preferably treated successively, so that the floor treatment appliance does not have to cover any large distances between the successively treated surrounding area subregions. The surrounding area subregions can be, for example, rooms or parts of a room. In the alternative, however, the surrounding area subregions can be defined independently of room borders. In successive time windows, the floor treatment appliance preferably moves along a predefined route through the plurality of defined surrounding area subregions. A user of the floor treatment appliance can thereby in particular define a starting point of the movement route. The floor treatment activity to be performed is thus initially pre-planned in that surrounding area subregion, which includes the starting point. Depending on the length of the time period of the subsequent time windows, further surrounding area subregions of the surrounding area, which are defined next on the route, are then treated.

It is proposed that the floor treatment appliance continues a floor treatment activity, which was stopped during the performance in a surrounding area subregion, at a predefined later start time in the same surrounding area subregion. As described above, the predefined later start time is synonymous with the beginning of a new time window, in which the continuance of the floor treatment activity is possible. It can be provided to continue the floor treatment activity at exactly those coordinates of the surrounding area subregion, at which the floor treatment appliance has previously stopped its floor treatment activity, or at another location of the same surrounding area subregion.

It can furthermore be provided that a surrounding area subregion of the surrounding area, in which a floor treatment activity has already been performed completely, is defined as a no-go region, which must not be treated by the floor treatment appliance once again, as long as all surrounding area subregions of the surrounding area have not been treated completely. According to this design, the floor treatment activity is ended completely in response to exceeding a time window, which is available for the complete floor treatment, by the time period required for the floor treatment activity, and the surrounding area subregions already treated until the end of the floor treatment activity are noted as no-go regions. For example, no-go regions can be stored in a surrounding area map, which is available to the floor treatment appliance, or alternatively in a separate file, which a control means of the floor treatment appliance can access. The no-go regions describe those portions of an entire area of the surrounding area, which are not to be treated subsequently, because a floor treatment activity has already been concluded there. In later time windows, the floor treatment appliance then only still treats those regions, which lie outside of the defined no-go regions or of the defined no-go region, respectively. When a complete floor treatment of the surrounding area has taken place upon the expiration of several defined time windows, the previously stored no-go regions are deleted again. A new floor treatment process can then be started, wherein no no-go regions have to be considered yet during the first time window of the new floor treatment process, because they were deleted after conclusion of the previously ended complete cleaning. Alternatively to the definition of no-go regions for already treated surrounding area subregions, a definition of treatment regions can alternatively also take place. These defined treatment regions define surrounding area subregions of the surrounding area, which have not been treated yet, which are to still be treated in later time windows. After closing a first time window, those surrounding area subregions, which are to still be treated, are defined as treatment regions. The magnitude of the treatment areas, which are still available, thus reduces from time window to time window. This procedure is continued until the treatment of the entire area of the surrounding area is concluded. When the floor treatment is ended completely and successfully, but remaining time of a currently running time window for performing a floor treatment is still available, a new floor treatment cycle can be started immediately, starting at an initial surrounding area subregion. This initial surrounding area subregion is preferably that surrounding area subregion, which was treated least recently, i.e. the floor treatment of which dates back longer than the floor treatment in other surrounding area subregions.

It is proposed that the defined no-go region or the defined treatment region, respectively, is deleted when the floor treatment appliance has completely treated all surrounding area subregions of the surrounding area. As described above, a new floor treatment cycle can then be started, which provides for a new floor treatment of the defined surrounding area subregions.

It is particularly advantageous in this context that the no-go region (or the treatment region, respectively) is only deleted when the time period of that time window has expired, into which a time period falls, at which all surrounding area subregions of the surrounding area are completely treated. It can be attained by means of this design that a specific time interval exists between two cycles of floor treatment activities, so that the surrounding area subregions are not treated successively without pause. It can thus be prevented or at least delayed, respectively, that the surrounding area subregions are treated too frequently one after the other and that an unnecessary energy expenditure or wear, respectively, of the floor treatment appliance thus occurs. In the case of very large time periods, which are available for one or several floor treatment activities, it can happen in particular that the entire surrounding area is treated twice or even several times in a row without pause. It is thus proposed that the no-go regions, which are the result of a last floor treatment activity of a cycle, are stored and are taken into account during a new start of a new cycle. It is attained thereby that in the event of an automatic new start of the floor treatment of the entire area, the surrounding area subregions, which have already been treated previously, are taken into account. It can thus be prevented that the surrounding area is treated several times in a row. It is advisable in this context that a minimum time interval is defined, which defines an interval, which is to be adhered to, between the conclusion of a complete treatment of the surrounding area and the new start of a new treatment process in the same surrounding area. Upon the expiration of this minimum time interval, a new start of a cycle with one or several floor treatment activities is then possible. This takes place by means of a deletion of the no-go regions or treatment regions, respectively, after the expiration of the defined minimum time interval.

It can furthermore be provided that specific surrounding area subregions of the surrounding area are to be treated more frequently than other surrounding area subregions. For example as part of a treatment plan, which includes several floor treatment activities, a repeated treatment of the specific surrounding area subregion in time intervals can be defined for this purpose. For example subareas can thus be prioritized, which must be treated daily, for example surrounding area subregions of a room or of a building, which get dirty frequently and which must thus be cleaned more often than other subareas of the surrounding area.

In addition to the above-described method, the invention furthermore proposes an automatically moving floor treatment appliance comprising a control means, which is configured to perform an above-described method. The floor treatment appliance can in particular be a cleaning appliance, which is configured to clean a floor area. The features and advantages described above with reference to the method according to the invention therefore also result for the floor treatment appliance. To avoid repetitions, reference is thus made to the above statements relating to the method according to the invention.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the drawings,

FIG. 1 shows a floor treatment appliance comprising a base station;

FIG. 2 shows a flowchart of a method according to the invention according to a first embodiment;

FIGS. 3A-F show floor treatment states of several surrounding area subregions of a surrounding area at various points in time;

FIG. 4 shows a flowchart of a method according to the invention according to a further embodiment;

FIGS. 5A-F show treatment states of several surrounding area subregions of a surrounding area at various points in time with reference to FIG. 4; and

FIG. 6 shows a flowchart of a method according to the invention according to a further embodiment.

### DETAILED DESCRIPTION OF PREFERRED EMBODIMENTS

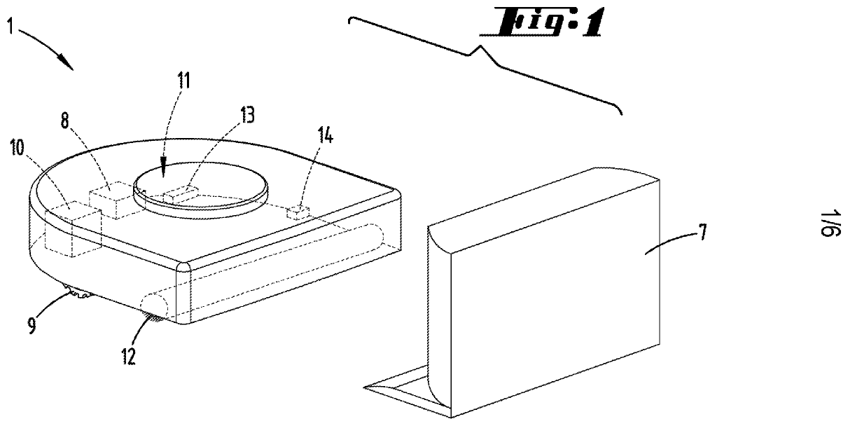

In an exemplary manner, FIG. 1 initially shows a floor treatment appliance 1 as well as a base station 7, which is configured to perform a service activity on the floor treatment appliance 1, for example to charge an accumulator (not illustrated) of the floor treatment appliance 1, to transfer tools to the latter, to clean the floor treatment appliance 1, or the like. The base station 7 furthermore represents an initial location for the floor treatment appliance 1, from which the floor treatment appliance 1 starts its movement routes.

The floor treatment appliance 1, which is illustrated in an exemplary manner, has a detection means 11, by means of which surrounding area data in the surrounding area of the floor treatment appliance 1 can be detected. The surrounding area data can be, for example, data of objects, which are located in the surrounding area, for example of walls, pieces or furniture, or the like. The detection means 11 can have, for example, an optical distance measuring means, e.g. a triangulation measuring means, which can measure distances from objects within the surrounding area. The detection means 11 has, for example, a laser diode, the emitted light beam of which is guided out of a housing of the floor treatment appliance 1 via a deflection means and can be rotated around an axis, which is perpendicular in the shown orientation of the floor treatment appliance 1, in particular in an angular range of 360 degrees. An all-around distance measurement around the floor treatment appliance 1 is possible thereby. The surrounding area can be measured in a preferably horizontal plane with the help of the detection means 11, i.e. in a plane, which is parallel to a floor area to be treated. The floor treatment appliance 1 can thus move by avoiding a collision with obstacles in the surrounding area. The surrounding area data recorded by means of the detection means 11 are preferably processed by a control means 8 of the floor treatment appliance 1 to form a surrounding area map, which the control means 8 can use, in turn, to navigate the floor treatment appliance 1 by avoiding obstacles. In addition to the detection means 11, the floor treatment appliance 1 can also have further sensors, for example a non-illustrated odometry sensor, which measures a distance covered by the floor treatment appliance 1. The floor treatment appliance 1 can furthermore also have, for example, a contact sensor, ultrasonic sensor, radar sensor, or the like. The floor treatment appliance 1 furthermore has a local memory 13, which is used, for example, to store the generated surrounding area map. Here, the floor treatment appliance 1 furthermore has a communication interface 14, via which the floor treatment appliance 1 can communicate with external end devices of a user of the floor treatment appliance 1. Such an external end device can be, for example, a mobile device of the user, in particular a mobile telephone, a tablet computer, or the like. An application, via which information relating to the floor treatment appliance 1 can be displayed to the user and inputs can be made for the operation of the floor treatment appliance 1, is preferably installed on the external end device. The installed application can in particular also have a calendar application, into which one or several pre-planned floor treatment activities are entered, which the floor treatment appliance 1 can perform at a defined point in time. The communication interface 14 can be, for example, a WLAN interface. The floor treatment appliance 1 is furthermore able to move automatically within the surrounding area. For this purpose, the floor treatment appliance 1 has motor-driven wheels 9. The floor treatment appliance 1 can additionally have one or several floor treatment elements 12, which are used to perform one or several floor treatment activities in the surrounding area. Here, the floor treatment appliance 1 is formed, for example, as a cleaning robot. The floor treatment element 12 can therefore be, for example, a cleaning element, in particular a rotating cleaning brush, alternatively a wiping cloth, a wiping roller, or the like. The floor treatment elements 12 are used to act on a floor area to be treated. The floor treatment appliance 1, which is formed as robot vacuum cleaner here, can furthermore have, e.g., in the usual way, a suction mouth opening, which is not further illustrated and via which suction material can be sucked into a suction material chamber of the floor treatment appliance 1 by means of a blower. A floor treatment appliance 1, which is alternatively formed as robot mop, could have, for example, a liquid application means, a liquid tank, and the like. For the power supply of the individual electric consumers of the floor treatment appliance 1, for example for a drive means 10 for driving the wheels 9 and a drive means 10 for driving the floor treatment element 12, the floor treatment appliance 1 preferably has a non-illustrated, re-chargeable accumulator, which can be charged by means of the base station 7.

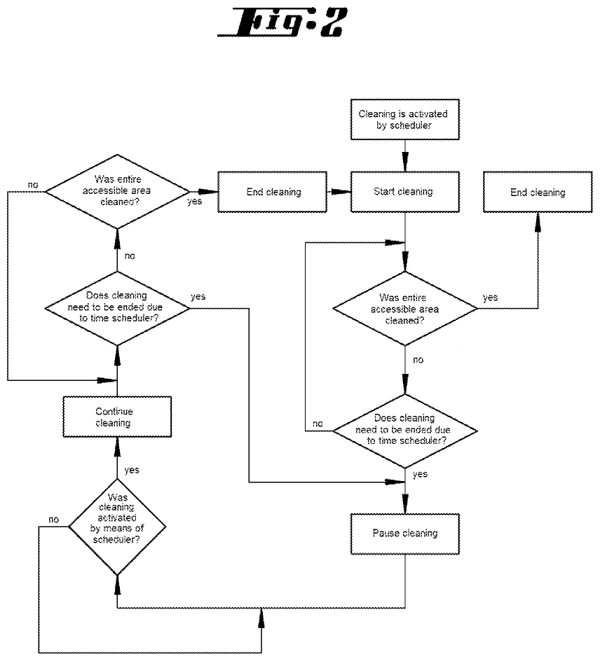

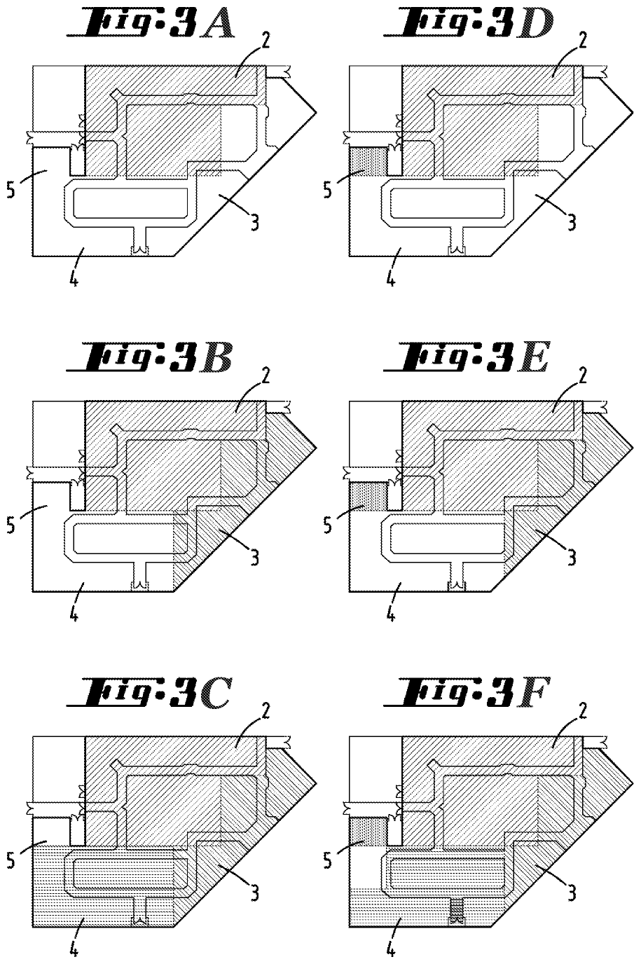

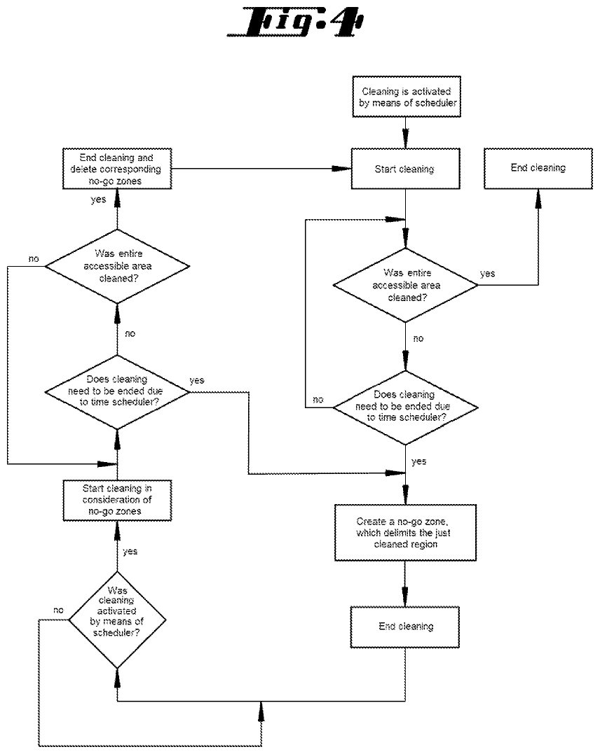

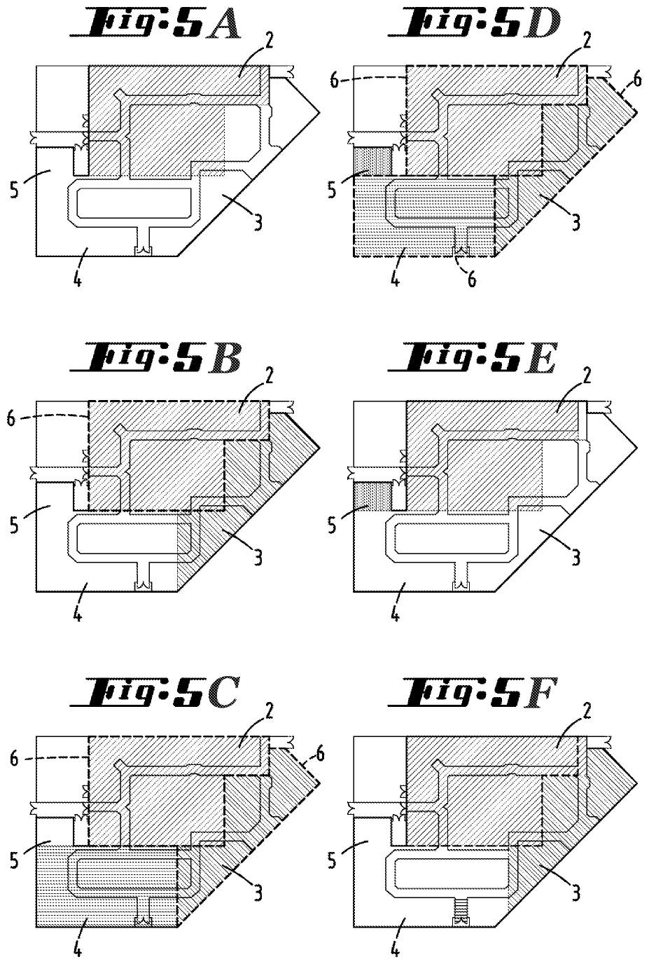

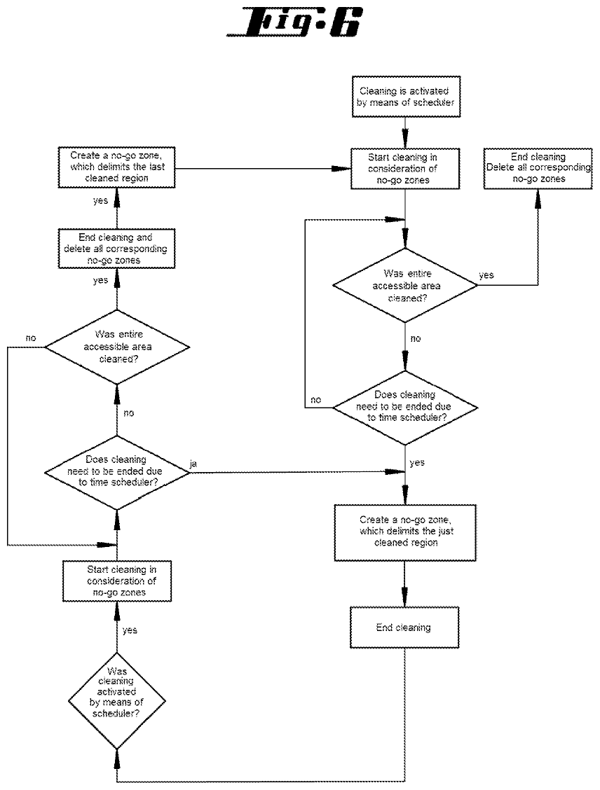

It will be described below in more detail on the basis of FIGS. 2 to 6, how the control means 8 of the floor treatment appliance 1 can control an operation of the floor treatment appliance 1 so that a surrounding area comprising very large floor areas to be treated can also be treated completely and optimally, without the user having to do this himself in a complex programming undertaking. FIGS. 2 and 3A to 3F thereby illustrate a first possible embodiment, FIGS. 4 and 5A to 5F illustrate a second possible embodiment, and FIG. 6 illustrates a further possible embodiment, whereby other embodiments furthermore also lie within the scope of the invention. It is in particular also possible that sub-combinations of the proposed approach can be made.

The initial situation for each of the embodiments illustrated below is that predefined time windows, in which the floor treatment appliance 1 may perform a floor treatment activity, are available for the floor treatment of several surrounding area subregions 2, 3, 4, 5 of the surrounding area. For example, the surrounding area can be an office environment, in which persons are present from 6 am until 8 pm, so that only the time period from 8 pm until 6 am is available as time window for the floor treatment on weekdays, as well as all day on Saturdays and Sundays. Due to the fact that the floor treatment of all surrounding area subregions 2, 3, 4, 5 cannot be concluded completely within a single time window from 8 pm until 6 am, it has to be interrupted. The time windows available for a floor treatment are preferably stored in the local memory 13 of the floor treatment appliance 1, so that the control means 8 of the floor treatment appliance 1 has knowledge as to when the floor treatment appliance 1 may be operated in the surrounding area, i.e. can move around in the surrounding area and can perform floor treatment activities there. A treatment plan to be executed can generally include only a single floor treatment activity or different floor treatment activities. The latter can be the case, for example, when the floor treatment appliance 1 is a combined vacuuming and mopping appliance, which successively performs a vacuuming activity first and then a mopping activity. The control means 8 controls the floor treatment appliance 1 on the basis of the treatment plan, wherein the floor treatment appliance 1 starts its movement route based on the location of the base station 7. Time windows, in which a floor treatment can take place within the surrounding area subregions 2 to 5 of the surrounding area, are noted in the treatment plan and/or the memory 13. Here, the calendrical treatment plan, for example for the weekdays Monday to Friday, in each case has successive time windows from 8 pm until 6 am, as well as all-day time windows on the Saturdays and Sundays, i.e. from midnight until midnight, thus in each case resulting in an extended time range at the interfaces to the preceding Fridays or Mondays, respectively. The time windows are characterized by a defined start time, for example 8 pm, and a defined time period, here, for example, ten hours. Time windows for performing a floor treatment activity thus exist at a transition from Monday to Tuesday, a transition from Tuesday to Wednesday, a transition from Wednesday to Thursday, etc.

The embodiment illustrated in FIGS. 2 and 3A-3F now works in such a way that the control means 8 accesses a treatment plan and gathers a start time for a pre-planned floor treatment activity therefrom. As soon as the start time of the next time window, which is available for the floor treatment, is reached, the control means 8 controls the floor treatment appliance 1 to perform a planned floor treatment activity, here, for example, the cleaning of a floor area in a first surrounding area subregion 2 of the surrounding area. As is illustrated in the flowchart according to FIG. 2, it is now permanently checked whether all surrounding area subregions 2, 3, 4, 5 of the surrounding area have already been cleaned. Provided that this is already the case during the first defined time window, the cleaning is ended. Provided that the cleaning of all surrounding area subregions 2 to 5 cannot be concluded within the first available time window, however, the cleaning is paused initially. The control means 8 then preferably controls the floor treatment appliance 1 to the base station 7, where for example the accumulator of the floor treatment appliance 1 can be charged again, and the floor treatment appliance 1 can additionally rest at a location where it does not disturb persons, who are present in the surrounding area subregions 2 to 5. The control means 8 subsequently gathers the start time of the next planned time window from the memory 13 of the floor treatment appliance 1, and starts the continuation of the previously paused cleaning activity as soon as the new time window is available for the activity of the floor treatment appliance 1. The cleaning of the surrounding area subregions 2 to 5 is now continued until all surrounding area subregions 2 to 5 are cleaned. Provided that the next available time window or the time period thereof, respectively, is also not sufficient to completely clean all surrounding area subregions 2 to 5, the cleaning process is paused again, until a next time window is available. As soon as the entire area of all of the surrounding area subregions 2 to 5 to be cleaned is finally completely treated, the cleaning job is ended. The control means 8 subsequently preferably controls the floor treatment appliance 1 to the base station 7 again, where the floor treatment appliance 1 then waits for a next cleaning job.

FIGS. 3A to 3F illustrate the surrounding area subregions 2 to 5, which are treated in the course of the execution of the cleaning plan. FIG. 3A thereby shows the treatment status of the surrounding area subregions 2 to 5 after ending of the first time window. FIG. 3B shows the treatment status of the surrounding area subregions 2 to 5 after a second time window, FIG. 3C shows the status accordingly after a third time window, etc. As can be seen, a first surrounding area subregion 2 is cleaned after conclusion of the first time window, a second surrounding area subregion 3 is additionally cleaned after conclusion of the second time window, a third surrounding area subregion 4 is additionally cleaned after conclusion of the third time window, and a fourth surrounding area subregion 5, plus a portion of the first surrounding area subregion 2, which has already been cleaned previously, is additionally cleaned after conclusion of a fourth tie window (FIG. 3D). The cyclical cleaning of the surrounding area subregions 2 to 5 can thus be seen, in the case of which the entire cleaning process starts all over again after successful treatment of all surrounding area subregions 2 to 5.

Due to the fact that, in practice, the time periods of the predefined time windows are not dimensioned so that they are always sufficient for a complete cleaning of a specific room, the surrounding area subregions 2 to 5, which are cleaned in subsequent time windows, change in relation to the surrounding area subregions 2 to 5, which are cleaned during a first pass. On the basis of the transition between the situations according to FIG. 3C and FIG. 3D, it can be seen, for example, that the entire area of all surrounding area subregions 2 to 5 is completely cleaned for the first time at a specific point in time. Immediately afterwards (FIG. 3D), a next cleaning process is then started and the cleaning of the surrounding area subregions 2 to 5 repeats itself. However, due to the changed initial situation, a new definition of the already cleaned surrounding area subregions 2 to 5 results. The starting of the next cleaning process can take place manually by a user or can be predefined for a fixed start time, in particular by means of a calendar app, which the control means 8 of the floor treatment appliance 1 can access.

FIGS. 4 and 5A to 5F show a further embodiment of a method according to the invention. This embodiment is similar to the process according to FIGS. 2 and 3A-3F, whereby the difference is here that upon the expiration of a time window, a final ending of the floor treatment activity and storage of the just cleaned surrounding area subregions 2 to 5 takes place instead of the pausing of the execution of a cleaning plan. In particular those surrounding area subregions 2 to 5, which have already been cleaned at the end of the time window, are stored as no-go regions 6. At the beginning of a new time window, the control means 8 of the floor treatment appliance 1 can thus check on the basis of the no-go regions 6 stored in the memory 13, which surrounding area subregions 2 to 5 of the surrounding area have already been cleaned and are to thus be excluded from a further cleaning activity. It can be seen in the flowchart according to FIG. 4 that in the event that the cleaning has to be ended due to the expiration of a time period of a time window, a no-go region 6 (no-go zone) is generated, which delimits the already cleaned surrounding area subregions 2 to 5 from the surrounding area subregions 2 to 5, which have not been cleaned yet. In the case of a subsequent new cleaning of the surrounding area after reaching the start time of a subsequent time window, it is initially checked, which surrounding area subregions 2 to 5 are part of such a no-go region 6. A new cleaning process is then started in consideration of the no-go region 6. When all of the surrounding area subregions 2 to 5, which are designated for cleaning, have been cleaned completely, the cleaning process is ended and the previously defined no-go regions 6 are deleted from the memory 13. A new cleaning process can be started subsequently. FIGS. 5A to 5F show the enlargement of the respective defined no-go regions 6 after conclusion of each passed-through time window.

Finally, FIG. 6 shows a further modification of a process according to the invention, which prevents that a start of a new cleaning cycles takes place immediately after a complete cleaning of all surrounding area subregions 2 to 5. This embodiment is particularly suitable in the case of very large available time windows, which define a time period, which is sufficient to completely clean all surrounding area subregions 2 to 5 of the surrounding area more than once. It is to be prevented thereby that the floor treatment appliance 1 becomes active even though the surrounding area subregions 2 to 5 have been cleaned only recently and it is to thus be assumed that the floor treatment appliance 1 cannot eliminate a relevant amount of dirt. This embodiment thus saves energy and additionally also prevents a shortening of the service life of the floor treatment appliance 1. As illustrated in the flowchart according to FIG. 6, this approach is similar to the embodiment according to FIGS. 4 and 5A to 5F, in the case of which no-go regions 6 were defined. According to the approach as now modified, the corresponding previously defined no-go regions 6 are initially deleted after the end of a complete cleaning of all surrounding area subregions 2 to 5 of the surrounding area, and a new no-go region 6 is defined subsequently, which comprises the last cleaned complete surface area all surrounding area subregions 2 to 5. When a new cleaning process is now started subsequently, either manually by a user or predefined by a cleaning plan, the control means 8 of the floor treatment appliance 1 initially checks whether no-go regions 6 are stored. When the control means then determines that all surrounding area subregions 2 to 5 are part of a no-go region 6, the cleaning job is ended or rejected, respectively. In the case of each new cleaning job, this approach then occurs until the no-go region 6 is released, i.e. was deleted. An end can be specified for the deletion of the no-go region 6, for example that a specific minimum time interval between successive time windows is adhered to, namely between a last time window of a first cleaning cycle and a first time window of a subsequent cleaning cycle.

Although only a few embodiments of the present invention have been shown and described, it is to be understood that many changes and modifications may be made thereunto without departing from the spirit and scope of the invention.

### LIST OF REFERENCE NUMERALS

1 floor treatment appliance
2 surrounding area subregion
3 surrounding area subregion
4 surrounding area subregion
5 surrounding area subregion
6 no-go region
7 base station
8 control means
9 wheel
10 drive means
11 detection means
12 floor treatment element
13 memory
14 communication interface

What is claimed is:

1. A method for operating an automatically moving floor treatment appliance (1), comprising the steps of:
pre-planning at least one floor treatment activity to be performed by the floor treatment appliance (1) in a surrounding area for performance in a first time window having a defined start time and a defined time period,
pre-planning at least a second time window in which the floor treatment appliance (1) continues the performance of the floor treatment activity, in the event that the first time window is not sufficient for complete performance of the floor treatment activity,
wherein the floor treatment activity not completed upon expiration of the first time window is stopped at an end of the defined time period of the first time window and is continued upon reaching a start time predefined for the second time window,
wherein several floor treatment activities are defined as part of a treatment plan, which establishes an order of the floor treatment activities to be performed,
wherein the floor treatment plan specifies a cyclically successive floor treatment of several surrounding area subregions (2, 3, 4, 5) of the surrounding area according to a defined sequence of the surrounding area subregions (2, 3, 4, 5),
wherein, after completion of a floor treatment activity in a surrounding area subregion (2, 3, 4, 5), which is defined as a last surrounding area subregion (2, 3, 4, 5) of the sequence, a new floor treatment of the surrounding area subregions (2, 3, 4, 5) takes place according to an entire defined sequence, starting at a surrounding area subregion (2, 3, 4, 5), which is defined as a first surrounding area subregion (2, 3, 4, 5) of the sequence.

2. The method according to claim 1, wherein the surrounding area is divided into a plurality of defined surrounding area subregions (2, 3, 4, 5), wherein the floor treatment activity is planned for performance in at least one specific one of the defined surrounding area subregions (2, 3, 4, 5).

3. The method according to claim 1, wherein the floor treatment appliance (1) continues a floor treatment activity, which was stopped during the performance in a surrounding area subregion (2, 3, 4, 5), at a predefined later start time in the same surrounding area subregion (2, 3, 4, 5).

4. The method according to claim 1, wherein a surrounding area subregion (2, 3, 4, 5) of the surrounding area, in which a floor treatment activity has already been performed completely, is defined as a no-go region (6), which must not be treated by the floor treatment appliance (1) once again, as long as all surrounding area subregions (2, 3, 4, 5) of the surrounding area have not been treated completely.

5. The method according to claim 4, wherein the defined no-go region (6) is deleted when the floor treatment appliance has completely treated all surrounding area subregions (2, 3, 4, 5) of the surrounding area.

6. The method according to claim 5, wherein the no-go region (6) is only deleted when the time period of that time window has expired, into which a time period falls, at which all surrounding area subregions (2, 3, 4, 5) of the surrounding area are completely treated.

7. The method according to claim 1, wherein at an end of one of the time windows, the floor treatment appliance (1) is moved to a base station (7) and rests at the base station until the start time of a subsequent time window is reached.

8. An automatically moving floor treatment appliance (1) comprising a control element (8), which is configured to perform a method according to claim 1, wherein the floor treatment appliance (1) is a cleaning appliance, which is configured to clean a floor area.
